(19) United States
(12) Patent Application Publication
(10) Pub. No.: US 2004/0162918 A1
(43) Pub. Date: Aug. 19, 2004

(54) System and method for invoking WebDAV methods via non-WebDAV communication protocols

(76) Inventors: Richard Freidman, Cherry Hill, NJ (US); Joseph John Snyder, Shamong, NJ (US); Jason A. Kinner, Marlton, NJ (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/368,268

(22) Filed: Feb. 17, 2003

(51) Int. Cl. G06F 15/16

(52) U.S. Cl. 709/246; 709/230

(57) ABSTRACT

A method for invoking a WebDAV method via a communication protocol that does not natively support WebDAV methods is provided. The method comprises receiving a request for a WebDAV method via a communication protocol that does not natively support WebDAV. The method further comprises invoking the requested WebDAV method, responsive to receiving the request.

### CROSS-REFERENCE TO RELATED APPLICATIONS

This application is related to concurrently filed and commonly assigned U.S. patent application Ser. No. [Attorney Docket No. 100203182-1] titled “SYSTEM AND METHOD FOR INVOKING WEBDAV METHODS VIA NON-WEBDAV PROTOCOLS”, and concurrently filed and commonly assigned U.S. patent application Ser. No. [Attorney Docket No. 100203178-1] titled “SYSTEM AND METHOD FOR INVOKING WEBDAV METHODS VIA COMPONENT TECHNOLOGIES”, the disclosures of which are hereby incorporated herein by reference.

### BACKGROUND

With the proliferation of digital assets, such as web pages, available today, it is often desirable to have a collaborative effort in working with such digital assets. For example, a plurality of World Wide Web (“Web”) developers in geographically distant locations may collaborate on a project. The Web has traditionally not provided a suitable environment for managing such a collaborative effort. More particularly, while the Web has traditionally allowed read access to documents, it has failed to provide suitable management necessary to allow collaborative authoring of documents. Thus, the collaborators have traditionally been required to use e-mail or other forms of communication to continuously notify/update each other of changes that have been or that need to be made to documents/code. That is, much of the burden of managing the collaboration on a Web project has been placed on the collaborators and has required the collaborators to keep each other updated as to their individual activities.

Hypertext Transfer Protocol (HTTP) is a well-known protocol that provides the set of rules for exchanging files (e.g., text, graphic images, sound, video, and other multimedia files) on the Web. HTTP alone does not natively support collaborative efforts. That is, HTTP does not natively enable clients to perform such management operations as locking a file, unlocking a file, retrieving properties of a file, etc., that are desirable in a collaborative environment.

In view of the above desire for managing collaborative efforts in the Web environment, a collaborative protocol known as “WebDAV” (World Wide Web Distributed Authoring and Versioning) has been developed recently. More particularly, WebDAV is the Internet Engineering Task Force (IETF) standard for collaborative authoring on the Web. WebDAV comprises a set of extensions to HTTP that facilitates collaborative editing and file management between users who may be located remotely from each other on the Internet.

WebDAV is expected to have an impact on the development of virtual enterprises by enabling remote groups to work together in new ways. For example, WebDAV-conforming tools could be used by a virtual organization to develop business plans, create software, or write libraries of information. WebDAV is making advances toward early expectations of the Web's collaborative potential, by adding write access to the read access afforded by HTTP. Thus, WebDAV provides a protocol that enables collaborative access of documents in which a plurality of different users may access, update, revise, and/or otherwise modify the documents. In other words, WebDAV provides a standard infrastructure for asynchronous collaborative authoring of documents across the Internet (or other suitable communication network). In this manner, WebDAV makes the Web analogous to a large-grain, network-accessible file system.

WebDAV methods have been developed for performing operations desired for managing such a collaborative access of documents. For instance, WebDAV methods are known for performing such operations as: 1) locking digital assets or “resources” (also known as concurrency control), which prevents accidental overwriting of files; 2) setting, deleting, and retrieving properties of digital assets (using the DAV protocol); 3) performing searches based on property values for locating digital assets on the Web (using the DASL protocol); and 4) namespace manipulation, which supports copy and move operations. In view of the above, WebDAV provides a set of methods that can be used for managing collaborative access of digital assets, such as Web documents. More particularly, WebDAV methods may be used for managing digital assets in a manner that enables collaborative access of the digital assets by a plurality of different clients (e.g., developers, etc.).

Traditionally, the WebDAV protocol is used by clients to invoke WebDAV methods. Other communication protocols do not provide the above collaborative operations, such as locking/unlocking digital assets and setting, deleting, and retrieving properties of digital assets. That is, non-collaborative protocols, such as File Transfer Protocol (FTP), Simple Mail Transfer Protocol (SMTP), Simple Object Access Protocol (SOAP), as examples, do not natively include methods such as the above-described WebDAV methods for managing digital assets. Accordingly, if a client desires to use WebDAV methods for managing a digital asset (e.g., for collaborative access of the digital asset with other clients), the client is traditionally required to utilize the WebDAV protocol for invoking the desired WebDAV methods (e.g., to lock/unlock a file, retrieve file properties, etc.).

### SUMMARY

In accordance with one embodiment disclosed herein, a method for invoking a WebDAV method via a communication protocol that does not natively support WebDAV methods is provided. The method comprises receiving a request for a WebDAV method via a communication protocol that does not natively support WebDAV. The method further comprises invoking the requested WebDAV method, responsive to receiving the request.

In accordance with another embodiment disclosed herein, a system for invoking a WebDAV method via a communication protocol that does not natively support WebDAV is provided. The system comprises means for receiving a request for a WebDAV method from a client via a communication protocol that does not natively support WebDAV. The system further comprises means for invoking the requested WebDAV method responsive to a received request.

In accordance with another embodiment disclosed herein, a bridge for enabling invocation of a WebDAV method via a communication protocol that does not natively support WebDAV methods is provided. The bridge comprises a receiver operable to receive a request for a WebDAV method from a client via a communication protocol selected from the group consisting of File Transfer Protocol (FTP), Simple Mail Transfer Protocol (SMTP), and Simple Object Access Protocol (SOAP). The bridge further comprises an input handler operable to translate a received request from any of any said communication protocol to a canonical format, and a request executor operable to translate a canonically formatted request to a WebDAV protocol request for invoking a requested WebDAV method.

In accordance with another embodiment disclosed herein, a computer-executable software code stored to a computer-readable medium is provided. The computer-executable software code comprises code for translating a request for a WebDAV method from a communication protocol that does not natively support WebDAV methods to a WebDAV protocol. The computer-executable software code further comprises code for invoking the requested WebDAV method via the WebDAV protocol.

### BRIEF DESCRIPTION OF THE DRAWINGS

FIG. 1 shows a system in which an example embodiment disclosed herein may be implemented;

FIG. 2 shows an example implementation of a bridge operable to receive a request for a WebDAV method via a non-WebDAV protocol and invoke the desired WebDAV method; and

FIG. 3 shows an example operational flow diagram of the bridge of FIG. 2.

### DETAILED DESCRIPTION

As described above, WebDAV is a well-known collaborative protocol. WebDAV is generally described in the reference by E. James Whitehead, Jr., titled “World-Wide-Web Distributed Authoring and Versioning (WebDAV): An Introduction,” in Standard View, Vol. 5, No. 1, March 1997, pages 3-8, the disclosure of which is hereby incorporated herein by reference. The WebDAV specification is described further in IETF Request For Comments (RFC) 2518 titled “HTTP Extensions for Distributed Authoring” by Y. Goland, E. Whitehead, A. Faizi, S. Carter, and D. Jensen, the Internet Society (1999), a copy of which is available at http://www.ietf.org/rfc/rfc2518.txt?number=2518, the disclosure of which is hereby incorporated herein by reference and is referred to herein as RFC 2518. More specifically, RFC 2518 describes WebDAV as an extension to the HTTP/1.1 protocol that allows clients to perform remote web content authoring operations. This extension provides a coherent set of methods, headers, request entity body formats, and response entity body formats that provide operations for:

Properties: The ability to create, remove, and query information about Web pages, such as their authors, creation dates, etc. Also, the ability to link pages of any media type to related pages.

Collections: The ability to create sets of documents and to retrieve a hierarchical membership listing (like a directory listing in a file system).

Locking/Unlocking: The ability to reversibly keep more than one person from working on a document at the same time. This prevents the “lost update problem”, in which modifications are lost as first one author then another writes changes without merging the other author's changes.

Namespace Operations: The ability to instruct the server to copy and move Web resources.

As mentioned above, WebDAV methods have been developed for performing operations often desired in managing a collaborative access of digital assets. Such operations are not available in native HTTP. As examples, the following WebDAV methods have been developed: 1) LOCK method, which is used to take out a lock of any access type; 2) UNLOCK method, which removes the lock identified by the lock token in the Lock-Token request header from the Request-URI; 3) PROPFIND method, which retrieves properties defined on the digital asset (or “resource”) identified by the Request-URI; 4) PROPATCH method, which processes instructions specified in the request body to set and/or remove properties defined on the digital asset (or “resource”) identified by the Request-URI; 5) MKCOL method, which may be used to create a new collection resource at the location specified by the Request-URI; 6) DELETE method, which deletes a digital asset (or “resource”) or collection of digital assets; 7) PUT method, which stores a digital asset to the supplied Request-URI; 8) COPY method, which creates a duplicate of the source resource identified by the Request-URI, in the destination resource identified by the URI in the Destination header; and 9) MOVE method, which is the logical equivalent of the COPY method followed by consistency maintenance processing, followed by a delete of the source, where all three actions are performed atomically. The above example WebDAV methods, as well as other known WebDAV methods, are described further in RFC 2518.

When working in a collaborative environment, WebDAV methods become desirable to utilize in order to manage the collaborative access of a digital asset. For instance, the issue of write control or locking is important in a collaborative environment. When two or more people can write to the same, unversioned document, changes can be lost as first one collaborator, then another makes changes without first merging in previous updates (the so-called “lost update problem”). WebDAV provides an exclusive write lock, which guarantees that only the lock owner can overwrite a locked resource, and a shared write lock, which allows a group of collaborators to work together on a resource. By supporting mechanisms for both shared and exclusive locking, WebDAV can accommodate a wide range of collaborations. In general, shared locks are desirable in environments in which collaborators are aware of each other's activities, and exclusive locks provide a higher degree of conflict avoidance for collaborators who are not in close contact. A lock discovery mechanism (a WebDAV “property” method) allows collaborators to find out if any locks exist on a Web resource. Because the Web is designed so that no lock is required to read a Web page, there is no concept of a read lock. An implication of this fact in a “writable” Web environment is that the contents of a digital asset may change without warning if a write lock is not owned on the digital asset.

As described above, clients have traditionally been required to use the WebDAV protocol in order to take advantage of any one or more of the WebDAV methods for managing a digital asset (e.g., Web document). That is, if a client desires to use WebDAV methods, such as those identified above, the client has traditionally been required to use the WebDAV protocol for invoking such WebDAV methods. However, it is often desirable to manage a digital asset (or “resource”) using a WebDAV method without using the WebDAV protocol to do so. For instance, a client may desire to utilize a non-WebDAV protocol, such as the various protocols described below, to invoke a WebDAV method for managing a digital asset. For instance, a client may desire to utilize a non-WebDAV protocol to request a WebDAV method for performing Properties, Collections, Locking, and/or Namespace operations, as examples, for managing a digital asset.

WebDAV methods are becoming increasingly popular, and as their popularity continues to increase it becomes more desirable for clients to access these methods via non-WebDAV protocols. That is, it is desirable to allow clients to access digital assets using WebDAV methods via different protocols (i.e., protocols other than WebDAV). For example, a client may desire to use non-collaborative communication protocols (i.e., protocols that do not natively provide the operations of the WebDAV methods), such as FTP, SMTP, or SOAP, to send a message to a WebDAV server to request access to digital assets via WebDAV methods (i.e., to invoke one or more WebDAV methods for managing a digital asset).

In many cases, a client may not want to use HTTP (with the WebDAV extension thereto) to access a digital asset. As an example, suppose a digital asset resides on the client's local computer in a WebDAV storage unit; the client may desire to use WebDAV methods to access the digital asset but would rather not use the HTTP protocol because that may result in performance degradation unnecessarily. As another example, a client may desire to send an e-mail to a file system to invoke WebDAV method(s) for certain digital assets (e.g., files). In this case, the client may not need immediate access to the digital assets, but may instead like to request to have one or more WebDAV methods invoked for the digital assets at some time in the future. The client would like the ability to send an email message requesting the WebDAV method(s) be invoked for the digital asset(s), and have those WebDAV method(s) eventually invoked by the WebDAV server.

Embodiments disclosed herein provide a system and method for enabling requests for WebDAV methods to be made via non-WebDAV protocols. In one embodiment, a “bridge” is provided that is capable of receiving a request that is not in the WebDAV protocol and is operable to invoke the requested WebDAV method for managing a digital asset. In this manner, clients may use non-WebDAV protocols to invoke WebDAV methods for managing digital assets. That is, clients are not constrained to using only the WebDAV protocol in order to take advantage of WebDAV methods for managing digital assets, but may instead use other protocols for requesting WebDAV methods to manage digital assets. Thus, the “bridge” provides a solution for enabling access to WebDAV methods via non-WebDAV protocols. That is, embodiments disclosed herein extend the WebDAV methods, such as those methods identified above, to non-WebDAV protocols.

Non-WebDAV communication protocols, as described herein, are taken to include any communication protocol that does not natively support WebDAV methods. In certain implementations of the bridge, examples include communication protocols such as File Transfer Protocol (FTP), Simple Mail Transfer Protocol (SMTP), and Simple Object Access Protocol (SOAP), as examples. Excluded are non-WebDAV component technologies such as Enterprise Java Beans (EJB), Component Object Model (COM), and Distributed Component Object Model (DCOM), which are not considered to be communication protocols.

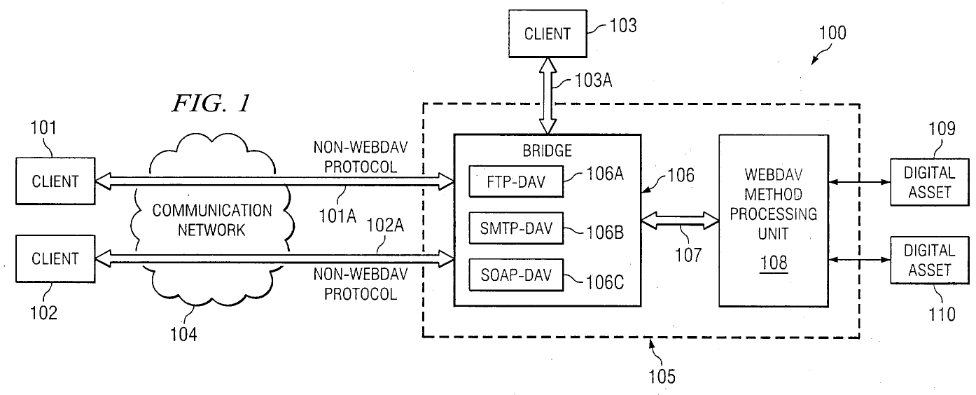

Turning to FIG. 1, a system of an example embodiment is shown. System 100 comprises one or more clients, such as clients 101 and 102, that are communicatively coupled to server 105 via communication network 104. Communication network 104 is preferably a packet-switched network, and in various implementations may comprise, as examples, the Internet or other Wide Area Network (WAN), an Intranet, Local Area Network (LAN), wireless network, Public (or private) Switched Telephony Network (PSTN), a combination of the above, or any other communications network now known or later developed within the networking arts that permits two or more computing devices to communicate with each other. Further, one or more clients, such as client 103 may be arranged local to server 105 and be communicatively coupled thereto.

In this example, server 105 comprises a WebDAV server that includes at least one WebDAV method processing unit 108. System 100 further comprises bridge 106, which is shown in this example as being implemented within server 105 but may in other embodiments be arranged external to server 105 and communicatively coupled thereto. As shown, bridge 106 is communicatively coupled to WebDAV method processing unit 108 via communication link 107. System 100 further comprises digital assets, such as digital assets 109 and 110, that are accessible via WebDAV method processing unit 108. That is, WebDAV method processing unit 108 is operable to perform WebDAV methods on digital assets 109 and 110. Digital assets 109 and 110 may comprise any type of digitally stored information, such as documents (e.g., Web documents), for example. WebDAV servers implementing WebDAV method processing units, such as processing unit 108, are well known in the art. WebDAV method processing unit 108 may comprise any suitable implementation now known or later discovered for receiving a request for a WebDAV method to be invoked for a digital asset (digital assets 109 and/or 110) and process the request to perform the appropriate actions associated with the invoked WebDAV method (e.g., locking a digital asset, etc.).

Bridge 106 comprises interfaces that enable it to receive requests from clients 101-103 via a plurality of different non-WebDAV communication protocols. For instance, remote client 101 is communicatively coupled to bridge 106 via communication link 101A, and communicates a request for a WebDAV method to be invoked for one or more of digital assets 109 and 110 to bridge 106 over such communication link 101A via a non-WebDAV communication protocol. As described further below, bridge 106 is operable to receive the request and invoke the desired WebDAV method for one or more of digital assets 109 and 110. Bridge 106 is further operable to communicate responses from the WebDAV method to client 101 over communication link 101A via the non-WebDAV communication protocol utilized by the client in requesting the WebDAV method. Similarly, remote client 102 may use a non-WebDAV communication protocol to communicate requests for WebDAV methods to bridge 106 over communication link 102A, and bridge 106 may communicate responses from the invoked WebDAV method back to client 102 via the non-WebDAV communication protocol used by client 102 in requesting the WebDAV method. Further, local client 103 may use a non-WebDAV communication protocol to communicate requests for WebDAV methods to bridge 106 over communication link 103A, and bridge 106 may communicate responses from the invoked WebDAV method back to local client 103 via the non-WebDAV communication protocol used by client 103 in requesting the WebDAV method. While three clients are shown in this example, it will be appreciated by those with ordinary skill in the art that any number of clients may be so included, and thus embodiments described herein are not limited solely to three clients.

In this example, bridge 106 comprises interfaces for receiving requests via FTP, SMTP, and SOAP, each of which is described further below. Bridge 106 comprises logic for interpreting a request received via a non-WebDAV communication protocol for invoking a requested WebDAV method. In this example, bridge 106 comprises logic 106A for interpreting an FTP request for invoking a WebDAV method requested thereby, logic 106B for interpreting an SMTP request for invoking a WebDAV method requested thereby, and logic 106C for interpreting a SOAP request for invoking a WebDAV method requested thereby.

Bridge 106 provides seamless access to WebDAV methods via any of a plurality of different non-WebDAV protocols. Of course, clients may communicate with server 105 using the WebDAV protocol, if desired. That is, embodiments disclosed herein do not preclude use of the WebDAV protocol by clients for invoking WebDAV methods. Rather, requests for WebDAV methods via the WebDAV protocol may be communicated to server 105 (either via bridge 106 or directly to WebDAV method processing unit 108), and such requests may be processed by WebDAV method processing unit 108 in a manner as is well known in the art.

While any non-WebDAV protocol may be used in alternative embodiments, bridge 106 in the example of FIG. 1 enables invocation of WebDAV methods via any of the following non-WebDAV communication protocols: FTP, SMTP, and SOAP, each of which is well known in the art and described briefly below.

File Transfer Protocol (FTP), a standard Internet protocol, is well-known and provides a very simple way to exchange files between computers on the Internet. Like HTTP, which transfers displayable Web pages and related files, and the Simple Mail Transfer Protocol (SMTP) described further below, which transfers e-mail, FTP is an application protocol that uses the Transmission Control Protocol/Internet Protocol (TCP/IP). That is, FTP and SMTP are TCP/IP-based protocols.

TCP/IP is a well-known protocol and is the basic communication language or protocol of the Internet. It can also be used as a communication protocol in a private network (e.g., either an intranet or an extranet). TCP/IP is a two-layer program. The higher layer, Transmission Control Protocol, manages the assembling of a message or file into smaller packets that are transmitted over the Internet and received by a TCP layer that reassembles the packets into the original message. The lower layer, Internet Protocol, handles the address part of each packet so that it gets to the right destination. Each gateway computer on the network checks this address to see where to forward the message. Even though some packets from the same message may be routed differently than others, they are reassembled at the destination.

FTP is a higher layer protocol that uses TCP/IP. FTP is commonly used to transfer Web page files from their creator to the computer that acts as their server for everyone on the Internet. FTP is also commonly used to download programs and other files to a client computer from other servers. Clients can use FTP with a simple command line interface (for example, from the Windows® MS-DOS® prompt window) or with a commercial program that offers a graphical user interface. A client's Web browser can also make FTP requests to download programs selected from a Web page by the client. Using FTP, a client can also update (delete, rename, move, and copy) files at a server.

As with FTP, Simple Mail Transfer Protocol (SMTP) is a TCP/IP-based protocol. SMTP is a well-known protocol that is commonly used in sending and receiving e-mail. However, because it is limited in its ability to queue messages at the receiving end, it is usually used with one of two other protocols, POP3 or Internet Message Access Protocol (IMAP), that let the user save messages in a server mailbox and download them periodically from the server. In other words, clients typically use a program that utilizes SMTP for sending e-mail and either POP3 or IMAP for receiving messages that have been received for them at their local server. Further details of SMTP are available in IETF RFC 821.

Another communication protocol known in the existing art is Simple Object Access Protocol (SOAP). SOAP provides a protocol that enables a program running in one kind of operating system (such as Windows(® 2000) to communicate with a program in the same or another kind of an operating system (such as Linux) by using HTTP and its Extensible Markup Language (XML) as the mechanisms for information exchange. Thus, SOAP (and similar protocols) may be referred to as a web service protocol. Because Web protocols, such as HTTP and XML, are installed and available for use by all major operating system platforms, these Web protocols provide an already at-hand solution to the problem of how programs running under different operating systems in a network can communicate with each other. SOAP specifies exactly how to encode an HTTP header and an XML file so that a program in one computer can call a program in another computer and pass it information. It also specifies how the called program can return a response. SOAP is somewhat similar to the Internet Inter-ORB Protocol (IIOP), a protocol that is part of the Common Object Request Broker Architecture (CORBA). Sun Microsystems' Remote Method Invocation (RMI) is a similar client/server interprogram protocol between programs written in Java. Thus, in certain embodiments, bridge 106 may comprise logic receiving requests for WebDAV methods via IIOP and/or RMI and invoking the desired WebDAV methods responsive to those requests, similar to that described below for SOAP.

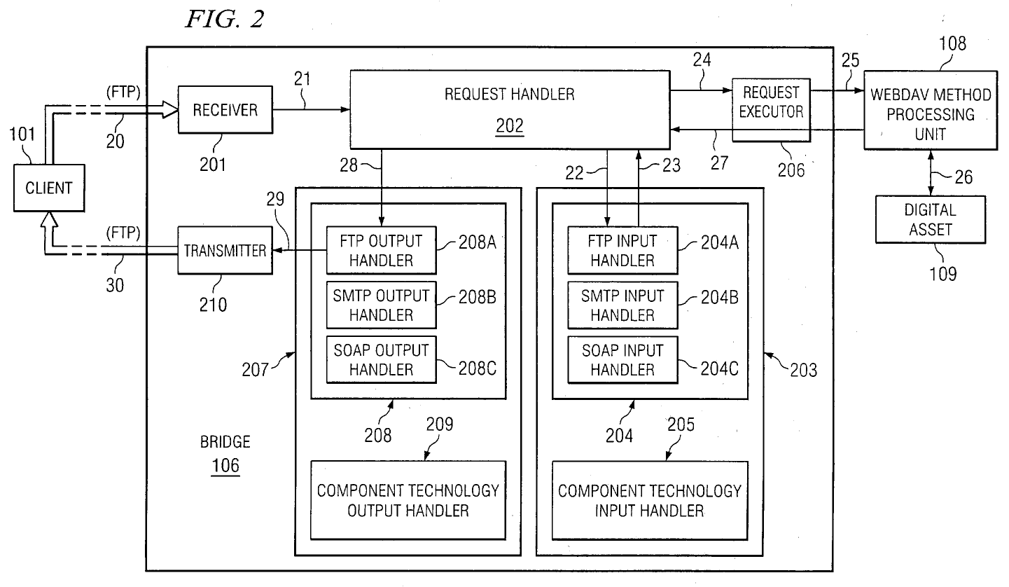

As described further hereinafter in conjunction with FIG. 2, certain embodiments of bridge 106 enable invocation of WebDAV methods via communication protocols, such as FTP, SMTP, and SOAP, that are not natively capable of invoking such WebDAV methods.

Turning now to FIG. 2, an example implementation of bridge 106 is shown. As shown, bridge 106 may comprise a receiver 201, request handler 202, input handlers 203, request executor 206, output handlers 207, and transmitter 210. As discussed further below, in certain embodiments, input handlers 203 comprise at least one communication protocol handler 204, such as FTP input handler 204A, SMTP input handler 204B, and SOAP input handler 204C. Similarly, in certain embodiments, output handlers 207 comprise at least one communication protocol handler 208, such as FTP output handler 208A, SMTP output handler 208B, and SOAP output handler 208C. Although shown as separate modules in the example implementation of FIG. 2, it should be understood that in alternative implementations various ones of the modules 201-204, 206-208, and 210 may be integrated together.

In operation, receiver 201 of bridge 106 is operable to receive a request from a client. More specifically, receiver 201 receives a request for invoking a WebDAV method for a digital asset, wherein such request is in a non-WebDAV communication protocol. Receiver 201 comprises an interface suitable for receiving such a request from a client, such as client 101. For instance, in the example shown in FIG. 2, client 101 communicates request 20 via FTP communication protocol to bridge 106. That is, request 20 is a FTP request to invoke a WebDAV method for digital asset 109 (e.g., to lock/unlock the digital asset, retrieve its properties, etc.). Receiver 201 receives the FTP request and sends it to request handler 202 via communication 21.

In an example embodiment, request handler 202 controls the request process. Receiver 201 is aware of the protocol it receives from a client and communicates the received request to the request handler 202. Request handler 202 determines the proper input handler for handling the received request. As described further below, bridge 106 comprises input handlers that are operable to receive a request that is in a non-WebDAV protocol and format the request into a canonical format. In certain implementations, multiple input handlers may be implemented for a given type of non-WebDAV protocol (e.g., multiple input handlers for FTP, etc.). Further, while one receiver 201 is shown in the example of FIG. 2, multiple receivers 201 may be implemented in bridge 106. For instance, a different receiver may be implemented for each non-WebDAV protocol supported by bridge 106. For example, an FTP receiver may be implemented in bridge 106 for receiving FTP requests, and one or more FTP input handlers 204A may be implemented within bridge 106 for formatting a received FTP request into a canonical format, as described further below.

In the example shown in FIG. 2, request handler 202 determines an appropriate input handler for handling the received FTP request. That is, request handler 202 determines which of the plurality of different non-WebDAV protocol input handlers 203 is suitable for handling the received request. More specifically, request handler 202 may determine an input handler 203 that is suitable for handling the received request based on the type of non-WebDAV protocol of the request. The type of non-WebDAV protocol (e.g., FTP, SMTP, SOAP, etc.) may be determined by request handler 202 based at least in part on the receiver 201 from which request handler 202 received the request. For instance, as mentioned above, a different receiver 201 may be implemented for each type of non-WebDAV protocol supported by bridge 106 in certain embodiments, and request handler 202 may therefore determine the type of non-WebDAV protocol of the request based at least in part on the receiver that received the request. For example, an FTP request may be received by an FTP receiver 201 and forwarded to request handler 202, which may determine (e.g., based on its receiving the request from the FTP receiver) that an FTP input handler is proper for handling the request. Accordingly, because the request in the example of FIG. 2 is in FTP, request handler 202 determines that FTP input handler 204A is the appropriate input handler for handling the received request. Accordingly, request handler 202 communicates the received request to FTP input handler 204A via communication 22.

The input handlers are operable to translate a request that is in a non-WebDAV protocol to a canonical format. That is, each of the input handlers 203 is operable to translate a request from a non-WebDAV protocol to a canonical format that request executor 206 is capable of processing. Examples of such a canonical format are described further below. Thus, in the specific example of FIG. 2, FTP input handler 204A translates the received FTP request to a canonical format, and then communicates the canonically formatted request back to request handler 202 via communication 23.

Then, request handler 202 determines that the request is for a WebDAV method and sends the canonically formatted request to request executor 206 via communication 24 for invocation of the requested WebDAV method. Request executor 206 maps the canonically formatted request to a WebDAV method. That is, request executor 206 translates the canonically formatted request into the WebDAV protocol for invoking the desired WebDAV method.

Request executor 206 then communicates the WebDAV request via communication 25 to WebDAV method processing unit 108. It should be recognized that in this example implementation WebDAV method processing unit 108 need not have any special functionality for handling the request received from request executor 206. Rather, a request received from request executor 206 may be treated just as if received from clients using the WebDAV protocol to invoke WebDAV methods. Request executor 206 translates the canonically formatted request to a WebDAV request that WebDAV method processing unit 108 processes just as typical requests that it receives from clients using the WebDAV protocol. WebDAV method processing unit 108 performs the requested WebDAV method on digital asset 109, as illustrated by action 26.

Typically, a WebDAV method provides some type of response indicating whether the requested WebDAV method was successful in its action and/or otherwise providing information (e.g., requested properties about the digital asset) back to the client who invoked the WebDAV method. Thus, request handler 202 receives such a response from WebDAV method processing unit 108 via communication 27 (which may be provided through request executor 206). Request handler 202 determines an appropriate output handler for handling the response to be output to the requesting client 101. That is, request handler 202 determines which of the plurality of different non-WebDAV communication protocol output handlers 207 is suitable for handling the response from WebDAV method processing unit 108 to be output to the requesting client 101.

Any of various techniques may be utilized by request handler 202 for determining an appropriate output handler for a response in accordance with embodiments of bridge 106. As one example, request handler 202 may be implemented to know the original input handler 203 used for the request for which the response is received (i.e., request handler 202 may keep track of the protocol used by a requesting client and/or the input handler 203 used for the request), and request handler 202 may use this information to determine the appropriate output handler for translating the WebDAV response to the non-WebDAV protocol used by the requesting client in requesting the WebDAV method that generated the response. As another example, request handler 202 may be implemented to analyze the response from executor 206 and make the determination of the appropriate output handler to use based at least in part on information embedded in the response itself (e.g., the size of the response or level of service information within the response). In general, the request handler may be implemented to provide the capability of communicating a WebDAV response back either synchronously or asynchronously to the client that requested the WebDAV method.

Because the request in the example of FIG. 2 was received from client 101 in FTP, request handler 202 determines that FTP output handler 208A is the appropriate output handler for providing the response to client 101 for the invoked WebDAV method. Accordingly, request handler 202 communicates the received WebDAV method response to FTP output handler 208A via communication 28.

Output handlers 207 are operable to translate a WebDAV response that is in WebDAV format to a non-WebDAV protocol. That is, each of output handlers 207 is operable to translate a response from the WebDAV protocol to a non-WebDAV protocol being used by the requesting client 101 for communication. In certain implementations, request executor 206 may be implemented to translate a received WebDAV response into a canonical format, and the output handlers 207 may be operable to translate the canonically formatted response to a non-WebDAV protocol used by the requesting client. In other implementations, the output handlers 207 are operable to receive a WebDAV response (that is not modified or reformatted in any way) and translate the WebDAV response to a non-WebDAV protocol. Thus, in the specific example of FIG. 2, FTP output handler 208A translates the WebDAV method response to FTP, and then communicates the FTP response to transmitter 210 via communication 29. Transmitter 210 then communicates the FTP response to client 101 via communication 30.

Thus, FIG. 2 illustrates an example in which a client 101 uses a non-WebDAV protocol (e.g., FTP) to invoke a WebDAV method and to receive a response (if any) generated from such WebDAV method. Bridge 106 provides the translation operations necessary to enable a WebDAV method to be invoked by a request that is in a non-WebDAV protocol. While communications between bridge 106 and client 101 are via FTP in the specific example shown in FIG. 2, it should be understood that the example bridge 106 shown in FIG. 2 enables communication with a client via any of a plurality of different non-WebDAV communication protocols, including SMTP and SOAP, in addition to FTP. Bridge 106 enables a WebDAV method to be invoked via any of these non-WebDAV protocols in a manner similar to that described above for FTP.

For instance, client 101 may communicate a request for invocation of a WebDAV method to bridge 106 via the SMTP or SOAP communication protocols. Receiver 201 would receive such request and communicate it to request handler 202, as with the above-described FTP request. Request handler 202 would determine the appropriate input handler to handle the request, such as SMTP input handler 204B or SOAP input handler 204C depending on which of these communication protocols was used by client 101 for sending the request. Request handler 202 sends the request to the selected input handler, which translates the request to a canonical format. Thereafter, as described above with the FTP request, the canonical format is sent to the request executor 206 for processing. Request executor 206 translates the canonically formatted request into a WebDAV protocol request and invokes the desired WebDAV method on WebDAV method processing unit 108. Any response received from WebDAV method processing unit 108 is communicated to the appropriate output handler, such as SMTP output handler 208B or SOAP output handler 208C depending on which of these communication protocols was used by client 101 for sending the request. The output handler translates the response into the non-WebDAV protocol used by the client for requesting the WebDAV method, and sends the translated response to transmitter 210, which communicates the response to client 101.

General example implementations that enable invocation of WebDAV methods via non-WebDAV protocols and component technologies, according to which bridge 106 may be implemented in certain embodiments, are described in co-pending U.S. patent application Ser. No. [Attorney Docket No. 100203182-1] titled “SYSTEM AND METHOD FOR INVOKING WEBDAV METHODS VIA NON-WEBDAV PROTOCOLS”, the disclosure of which has been incorporated herein by reference. Also, more specific example implementations that enable invocation of WebDAV methods via non-WebDAV component technologies, according to which bridge 106 may be implemented in certain embodiments, are described in co-pending U.S. patent application Ser. No. [Attorney Docket No. 100203185-1] titled “SYSTEM AND METHOD FOR INVOKING WEBDAV METHODS VIA COMPONENT TECHNOLOGIES”, the disclosure of which has been incorporated herein by reference.

The example implementation of bridge 106 in FIG. 2 is somewhat similar in its configuration to a Universal Listener Framework (ULF) proposed by Hewlett-Packard Company (HP) that enables translation of a plurality of different communication protocols to HTTP (for more information about such ULF proposed by HP, see the white paper titled “the universal listener framework™: a powerful, rapid-deployment request broker for mission critical communications enabled by Total-e-Server™” available at http://www.hpmiddleware.com/downloads/pdf/02-27-0_ULFWhitePaper.pdf, 2001, the disclosure of which is hereby incorporated herein by reference). However, rather than translating between any of a plurality of different protocols and HTTP, bridge 106 of FIG. 2 enables translation between any of a plurality of different protocols and WebDAV methods. That is, bridge 106 of FIG. 2 enables translation of any of a plurality of different non-WebDAV protocols directly into WebDAV for invoking WebDAV methods via such non-WebDAV protocols.

It should be recognized that the example embodiment of bridge 106 described in FIG. 2 is very flexible and scalable. For instance, bridge 106 can be easily adapted to support any combination of desired non-WebDAV protocols. More specifically, for a particular non-WebDAV protocol, an input handler module that is capable of receiving a request in the particular non-WebDAV protocol and translate it to the canonical format may be included in the bridge 106. Further, an output handler module that is capable of receiving a WebDAV response and translate the response to the particular non-WebDAV protocol may be included in the bridge 106, and request handler 202 may be implemented to recognize the newly added input handler and output handler modules. In this implementation, request executor 206 need not be modified to support additional non-WebDAV protocols, as the input handler for an additional non-WebDAV protocol translates a request into a canonical format that is recognized by request executor 206. Further, WebDAV method processing unit 108 need not have its implementation modified, as bridge 106 provides the interpretations/translations necessary for enabling any of a plurality of different non-WebDAV protocols to invoke WebDAV methods.

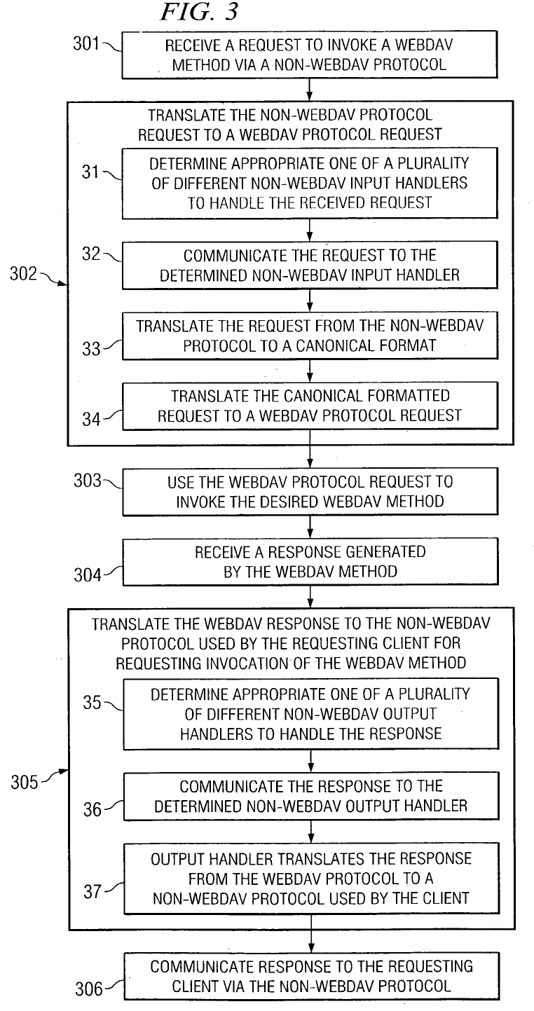

Turning to FIG. 3, an example operational flow diagram of one embodiment of a bridge 106 is shown. As shown, the bridge receives a request to invoke a WebDAV method via a non-WebDAV protocol in operational block 301. That is, in operational block 301 bridge 106 receives a request that is in a non-WebDAV protocol (e.g., FTP request 20 in FIG. 2) that is not natively capable of invoking a WebDAV method. In operational block 302, bridge 106 translates the non-WebDAV protocol request to a WebDAV protocol request. More specifically, in certain implementations such translation of block 302 may be performed in accordance with sub-blocks 31-34 shown in FIG. 3. Of course, in alternative implementations other techniques may be used for performing the translation of block 302. In the specific example shown in FIG. 3, bridge 106 determines an appropriate one of a plurality of different non-WebDAV input handlers 203 to handle the received request in sub-block 31. In sub-block 32, the received request is communicated to the determined appropriate non-WebDAV input handler. In sub-block 33, the input handler translates the request from the non-WebDAV protocol to a canonical format. In sub-block 34, the canonically formatted request is processed to construct a WebDAV protocol request (i.e., a request for the desired WebDAV method in the WebDAV protocol). That is, the canonically formatted request is translated into a WebDAV protocol request in sub-block 34.

In operational block 303, the WebDAV protocol request is used to invoke the desired WebDAV method. Then, in operational block 304, a response generated by the invoked WebDAV method is received by the bridge. The bridge translates the WebDAV response to the non-WebDAV protocol used by the requesting client for requesting invocation of the WebDAV method in operational block 305. More specifically, in certain implementations such translation of block 305 may be performed in accordance with sub-blocks 35-37 shown in FIG. 3. Of course, in alternative implementations other techniques may be used for performing the translation of block 305. In the specific example shown in FIG. 3, bridge 106 determines an appropriate one of a plurality of different non-WebDAV output handlers 207 to handle the received response in sub-block 35. In sub-block 36, the received WebDAV response is communicated to the determined appropriate non-WebDAV output handler. In sub-block 37, the output handler translates the response from the WebDAV protocol to a non-WebDAV protocol (e.g., the non-WebDAV protocol used by the client in invoking the WebDAV method). In operational block 306, bridge 106 communicates the response to the requesting client via the non-WebDAV protocol.

As described above, in certain embodiments of bridge 106, input handlers 203 are operable to translate a non-WebDAV protocol request to a canonical format. Various techniques exist for translating a received request into a canonical format. In certain implementations, the input handlers 203 retrieve information that is included within the request itself and organizes the information into a canonical format that can be processed by request executor 206. For example, the canonical format may comprise a table in certain implementations. An example table structure is shown as Table 1 below.

TABLE 1

| | |
|---|---|
| Requested WebDAV Method: | Lock |
| Digital Asset: | Digital Asset 109 |
| Requesting Client: | Client 101 |
| Protocol of Request: | FTP |

In the example of Table 1, the first column of the table identifies various information that may be obtained for a received request, such as the requested WebDAV method(s), the digital asset(s) for which the method is requested, the requesting client, and the protocol of the request. The second column of the table provides values corresponding to each of the fields of information of the first column. For instance, in the example of Table 1, the requested WebDAV method is identified as the Lock method. The digital asset for which the method is requested is identified as “Digital Asset 109” (which is consistent with the example of FIG. 2 and which may actually include a file name or other suitable identification of the digital asset). The requesting client is identified as “Client 101” (which is likewise consistent with the example of FIG. 2 and may actually include a client's IP address or other suitable identification of the requesting client). The protocol of the request is FTP (which is likewise consistent with the example of FIG. 2).

Again, the information of Table 1 may be populated by the input handler processing a received request. Such input handler may analyze the received request (e.g., the body of the request) and retrieve the information for the fields of Table 1 from such request. Certain rules may be imposed on clients regarding how certain information, such as identification of the WebDAV method to be invoked and identification of the digital asset for which the WebDAV method is to be invoked, is to be arranged within a request to enable an input handler to better identify such information from the request.

As an example of translating a request for a WebDAV method from a non-WebDAV communication protocol to a canonical format, such as that of Table 1 above, suppose a request for a WebDAV method is received at the bridge as an e-mail message in SMTP. In one implementation, the body of the e-mail message may contain text identifying the WebDAV method to be invoked and the digital asset for which it is to be invoked. For instance, the body of the email message may be formatted as “METHOD DIGITAL_ASSET”, wherein METHOD is the WebDAV method to invoke and “DIGITAL_ASSET is the digital asset for which the method is to be invoked. For example, the body of the e-mail message may specify “LOCK FILE_A”, wherein a lock method is requested for the digital asset FILE_A. In this implementation, the SMTP input handler may be operable to analyze the body of the e-mail message and identify the requested WebDAV method and the digital asset for which the method is requested, and the SMTP input handler populates a table (such as Table 1) with the discovered information (or otherwise constructs it into a canonical format).

In another implementation, the subject field of the e-mail message may identify the type of WebDAV method to be invoked and the body of the e-mail message may identify the digital asset for which the method is to be invoked. For instance, continuing with the above example, the subject field of the e-mail message may specify “LOCK” and the body of the e-mail message may specify “FILE_A”. In this implementation, the SMTP input handler may be operable to analyze the subject field of the e-mail message to identify the requested WebDAV method and analyze the body of the e-mail message to identify the digital asset for which the method is requested. The SMTP input handler may populate a table (such as Table 1) with the discovered information (or otherwise construct it into a canonical format).

As still another example implementation, the address to which the e-mail message is sent may identify the type of WebDAV method to be invoked and the body of the e-mail message may identify the digital asset for which the method is to be invoked. For instance, continuing with the above example, the e-mail message may be sent to “lock@webdavserver.com”, and the body of the e-mail message may specify “FILE_A”. In this implementation, the SMTP input handler may be operable to identify the requested WebDAV method from the address to which the e-mail was sent (i.e., from “lock@webdavserver.com”), and analyze the body of the e-mail message to identify the digital asset for which the method is requested. The SMTP input handler may populate a table (such as Table 1) with the discovered information (or otherwise construct it into a canonical format).

From the above examples, one of ordinary skill in the art will appreciate that various techniques may be used for including information for invoking a WebDAV method within a request that is communicated to bridge 106 via a non-WebDAV communication protocol, and input handlers 203 may then analyze the received request to determine such information and construct it into a canonical format (such as a table) that can be used by request executor 206 for invoking the desired WebDAV method. While a table is shown in the example above, it should be understood that other canonical formats may be used in alternative embodiments. Preferably, the same canonical format is used for each of the plurality of different non-WebDAV communication protocols. That is, preferably, each of the plurality of non-WebDAV input handlers construct their requests into a common canonical format, such that request executor 206 receives substantially the same canonically formatted request irrespective of whether the request originated from a client using FTP, a client using SMTP, or a client using some other non-WebDAV communication protocol.

What is claimed is:

1. A method for invoking a WebDAV method via a communication protocol that does not natively support WebDAV methods, the method comprising:
receiving a request for a WebDAV method via a communication protocol that does not natively support WebDAV; and
responsive to receiving said request, invoking the requested WebDAV method.

2. The method of claim 1 further comprising:
translating the received request to a WebDAV protocol.

3. The method of claim 2 wherein said invoking comprises:
communicating the translated request via said WebDAV protocol to a WebDAV method processing unit.

4. The method of claim 1 further comprising:
translating the received request to a canonical format.

5. The method of claim 4 further comprising:
translating the canonically formatted request to a WebDAV protocol.

6. The method of claim 1 further comprising:
communicating said request to an input handler; and
said input handler translating said received request to a canonical format.

7. The method of claim 6 further comprising:
communicating said canonically formatted request to a request executor; and
said request executor translating said canonically formatted request to a WebDAV protocol and communicating the request via said WebDAV protocol to a WebDAV method processing unit.

8. The method of claim 1 wherein said communication protocol that does not natively support WebDAV methods comprises any one selected from the group consisting of:
File Transfer Protocol (FTP), Simple Mail Transfer Protocol (SMTP), and Simple Object Access Protocol (SOAP).

9. A system for invoking a WebDAV method via a communication protocol that does not natively support WebDAV, the system comprising:
means for receiving a request for a WebDAV method from a client via a communication protocol that does not natively support WebDAV; and
means for invoking the requested WebDAV method responsive to a received request.

10. The system of claim 9 further comprising:
means for translating a received request from said communication protocol that does not natively support WebDAV to a WebDAV protocol.

11. The system of claim 9 further comprising means for translating a received request from a communication protocol that does not natively support WebDAV to a canonical format.

12. The system of claim 11 further comprising:
means for translating a canonically formatted request to a WebDAV protocol request.

13. The system of claim 9 wherein said communication protocol that does not natively support WebDAV methods comprises any one selected from the group consisting of:
File Transfer Protocol (FTP), Simple Mail Transfer Protocol (SMTP), and Simple Object Access Protocol (SOAP).

14. A bridge for enabling invocation of a WebDAV method via a communication protocol that does not natively support WebDAV methods, the bridge comprising:
a receiver operable to receive a request for a WebDAV method from a client via a communication protocol selected from the group consisting of:
File Transfer Protocol (FTP), Simple Mail Transfer Protocol (SMTP), and Simple Object Access Protocol (SOAP);
an input handler operable to translate a received request from any of any said communication protocol to a canonical format; and
a request executor operable to translate a canonically formatted request to a WebDAV protocol request for invoking a requested WebDAV method.

15. The bridge of claim 14 wherein said canonical format comprises a table.

16. Computer-executable software code stored to a computer-readable medium, said computer-executable software code comprising:
code for translating a request for a WebDAV method from a communication protocol that does not natively support WebDAV methods to a WebDAV protocol; and
code for invoking the requested WebDAV method via said WebDAV protocol.

17. The computer-executable software code of claim 16 wherein said code for translating further comprises:
code for translating said request to a canonical format.

18. The computer-executable software code of claim 17 wherein said code for translating said request for a WebDAV method from a communication protocol that does not natively support WebDAV methods to a WebDAV protocol further comprises:
code for translating the canonically formatted request to a WebDAV protocol.

19. The computer-executable software code of claim 16 further comprising:
code for communicating the received request to an input handler; and
said input handler comprising code for translating said received request to a canonical format.

20. The computer-executable software code of claim 19 further comprising:
code for communicating said canonical formatted request to a request executor; and
said request executor comprising code for translating said canonically formatted request to said WebDAV protocol.

21. The computer-executable software code of claim 16 wherein said communication protocol that does not natively support WebDAV methods comprises any one selected from the group consisting of:
File Transfer Protocol (FTP), Simple Mail Transfer Protocol (SMTP), and Simple Object Access Protocol (SOAP).
